(19) United States
(12) Patent Application Publication
(10) Pub. No.: US 2012/0040545 A1
(43) Pub. Date: Feb. 16, 2012

(54) TRANSCEIVER CONNECTOR HAVING IMPROVED RELEASING MECHANISM

(75) Inventors: CHIEN-CHIUNG WANG, New Taipei (TW); QING-MAN ZHU, Kunshan (CN); XUE-LIANG ZHANG, Kunshan (CN)

(73) Assignee: HON HAI PRECISION INDUSTRY CO., LTD., New Taipei (TW)

(21) Appl. No.: 13/194,130

(22) Filed: Jul. 29, 2011

(30) Foreign Application Priority Data
Aug. 10, 2010 (CN) 201020287958.0

(51) Int. Cl. H01R 13/62

(52) U.S. Cl. 439/157

(57) ABSTRACT

A transceiver connector (100) is adapted for inserting into a receptacle (400) having a latching tab (41) defining a latching hole (411). The transceiver includes a releasing mechanism (3) and a housing (1) having a pair of sliding slots (132) and a latching protrusion (121) latched with the latching hole. The releasing mechanism includes an actuator (31) defining a pair of inserting holes (315), a sliding member (32) including a through hole (325) and a releasing portion (322) having an expelling portion (324) and an inserting portion (323), and a pivot (33) inserting though the inserting holes, the sliding slots and the through hole. The inserting portion inclines at a first angle smaller than a second angle at which the expelling portion inclines. The sliding member is movable forwardly to insert the inserting portion beneath the latching tab and then to move the expelling portion to expel the latching tab outwardly to release the latching protrusion from the latching hole.

### BACKGROUND OF THE INVENTION

1. Field of the Invention

The present invention relates to a transceiver connector, and more particularly to a SFP (Small Form-Factor Pluggable) transceiver connector adapted for releasably latching with a receptacle.

2. Description of Related Art

U.S. Patent Application Publication No. 2009/0274468 published on Nov. 5, 2009 discloses an SFP transceiver connector mating with a receptacle having a latching tab defining a latching hole. The transceiver connector comprises a housing having a latching protrusion engaging with the latching hole, and a releasing mechanism assembled to the housing. The releasing mechanism includes an actuator, a lever assembled at one end of the actuator, a pivot, and a sliding member mounted at another end of the actuator and the housing via the pivot. The lever operates the sliding member moving from a latched position to a released position. The sliding member includes a releasing portion having an inclined releasing face for being inserted beneath the latching tab and expelling the latching tab to release the latching protrusion from the latching hole.

The releasing portion may be further improved to make the releasing operation more easily and labor-savingly.

Hence, a transceiver connector having an improved releasing mechanism is desired.

### SUMMARY OF THE INVENTION

Accordingly, an object of the present invention is to provide a transceiver connector including a releasing mechanism having a releasing portion having an inserting portion and an expelling portion inclined at different angles to take a releasing operation more easily and reliably.

In order to achieve the object set forth, a transceiver connector is adapted for inserting into a receptacle having a latching tab defining a latching hole. The transceiver includes a releasing mechanism and a housing having a pair of sliding slots and a latching protrusion latched with the latching hole of the receptacle. The releasing mechanism includes an actuator defining a pair of inserting holes, a sliding member including a through hole and at least one releasing portion having an expelling portion and an inserting portion connected with and situated in front of the expelling portion, and a pivot inserting though the inserting holes of the actuator, the sliding slots of the housing and the through hole of the sliding member. The inserting portion inclines at a first angle smaller than a second angle at which the expelling portion inclines. The sliding member is movable forwardly by the actuator to insert the inserting portion of the sliding member beneath the latching tab and then to move the expelling portion to expel the latching tab outwardly to release the latching protrusion from the latching hole of the receptacle.

The inserting portion of the sliding member inclines at the first angle of a smaller degree for inserting beneath the latching tab 41 easily. The expelling portion of the sliding member inclines at the second angle of a larger degree for expelling the releasing tab outwardly more easily and laborsavingly. The releasing operation is easy to perform. The releasing portion inclines at one angle as described in the prior art would have the releasing operation more difficult.

Other objects, advantages and novel features of the invention will become more apparent from the following detailed description when taken in conjunction with the accompanying drawings.

### BRIEF DESCRIPTION OF THE DRAWINGS

FIG. 1 is an assembled perspective view showing a transceiver connector in accordance with a first embodiment of the present invention;

FIG. 2 is an exploded perspective view showing the transceiver connector as shown in FIG. 1;

FIG. 3 is a perspective view showing a sliding member;

FIG. 4 is an assembled perspective view showing the transceiver connector latching with the receptacle;

FIG. 5 is a cross-sectional view of the transceiver connector and the receptacle in a latched position, taken along line 5-5 of FIG. 4;

FIG. 6 is a cross-sectional view of the transceiver connector and the receptacle in a released position, taken along line 5-5 of FIG. 4; and

FIG. 7 is a perspective view showing the sliding member referred in a second embodiment.

### DETAILED DESCRIPTION OF THE PREFERRED EMBODIMENT

Reference will now be made in detail to the preferred embodiment of the present invention.

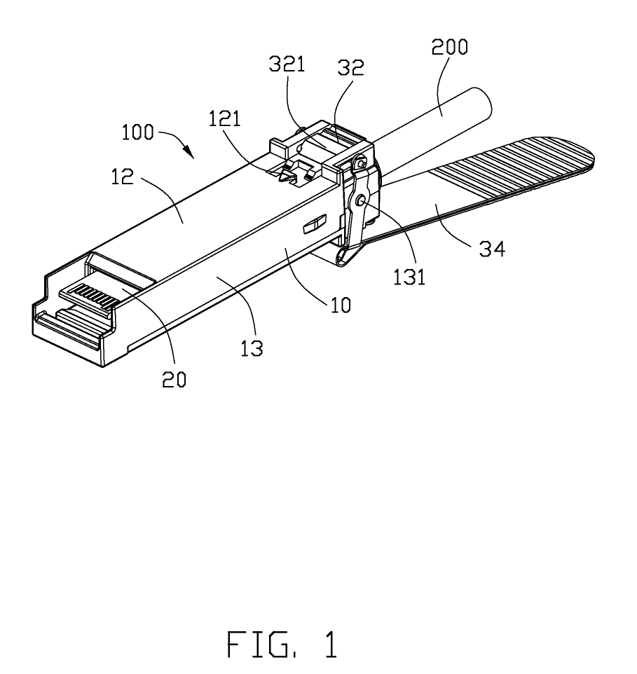

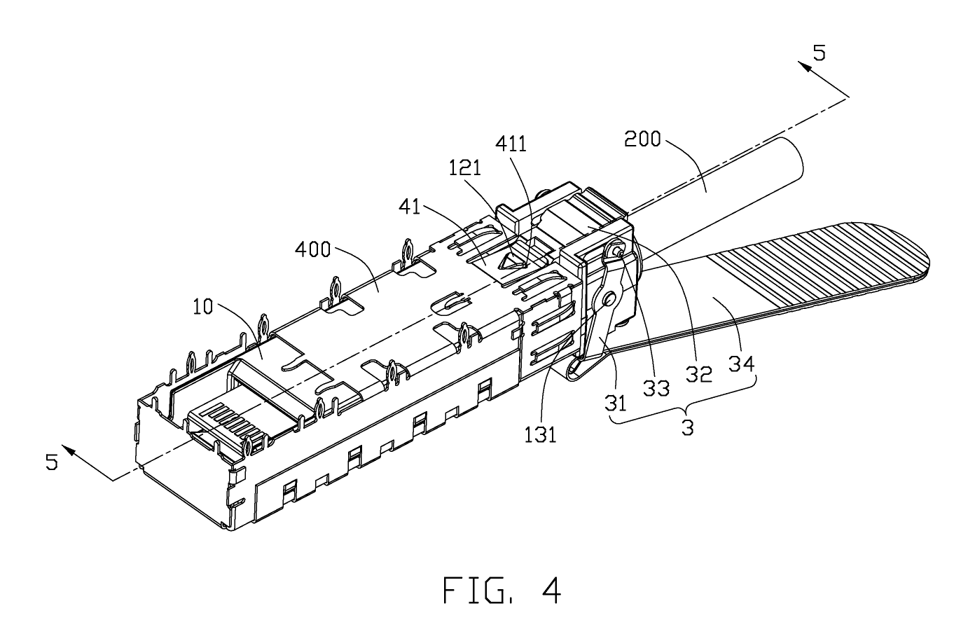

Referring to FIGS. 1 and 4, a transceiver connector 100 in accordance with a first embodiment is connected with a cable 200 and is adapted for inserting into a receptacle 400 having a latching tab 41 defining a latching hole 411.

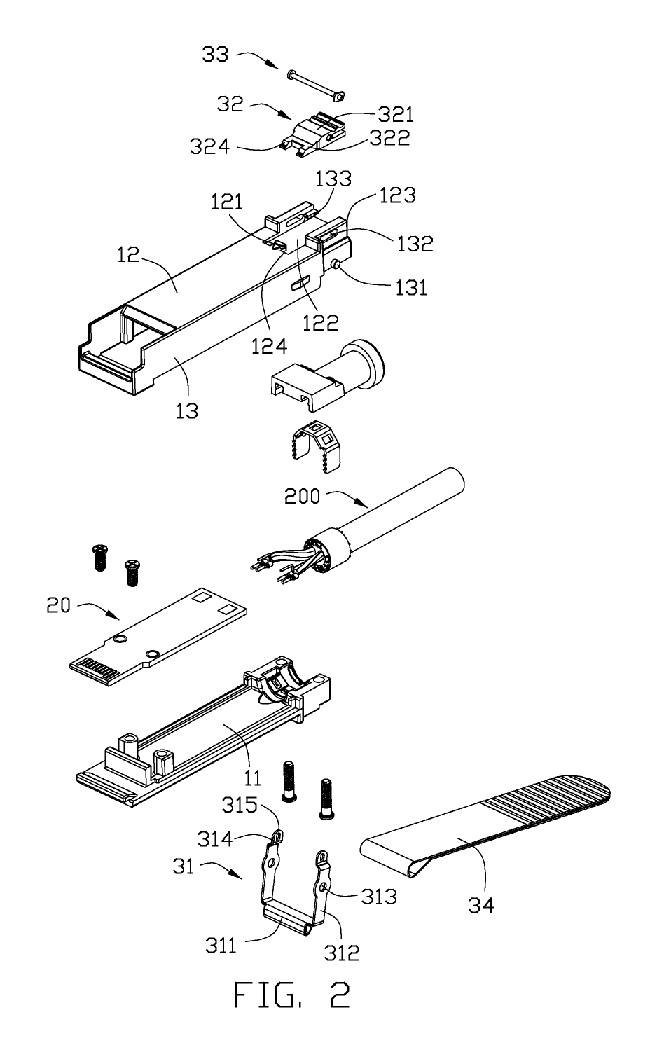

Referring to FIGS. 1 and 2, the transceiver connector 100 comprises a housing 10 insertion of at least one board 20 connected with the cable 200, and a releasing mechanism 3 assembled to the housing 10. The housing 10 comprises a bottom wall 12, a pair of side walls 13, and a separatable top wall 11. The housing 10 includes a concave recess 122 recessed from the bottom wall 12, a latching protrusion 121 formed at a front end of the concave recess 122, a pair of supporting portions 123 extending downwardly from opposite sides of the concave recess 122, and a pair of protrusions 131 respectively projecting outwardly from the pair of side walls 13. The concave recess 122 is recessed from the bottom wall 12 to form a pair of stepped portions 124 at opposite sides of the latching protrusion 121. Each supporting portion 123 defines a longitudinally extending sliding slot 132 and an inwardly projecting platform 133 behind the sliding slot 132.

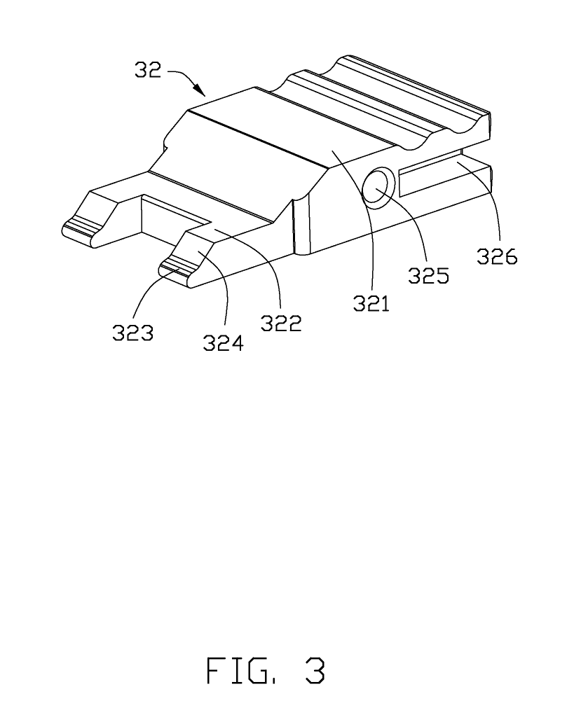

Referring to FIGS. 2 and 3, the releasing mechanism 3 comprises an actuator 31, a lever 34, a sliding member 32, and a pivot 33.

The actuator 31 includes a handle portion 311, and a pair of beam portions 312 extending from opposite ends of the handle portion 311. Each beam portion 312 has a mounting hole 313 defined at substantially a middle portion of the beam portion 312, and an inserting hole 315 defined at a free end 314 of the beam portion 312.

The sliding member 32 includes a body portion 321, a pair of releasing portions 322 extending forwardly from the body portion 321, a through hole 325 extending through the body portion 321 along the transverse direction, and a pair of restricting slots 326 behind the through hole 325.

Each releasing portion 322 includes an expelling portion 324 extending from the body portion 321, and an inserting portion 323 extending forwardly from the expelling portion 324. The inserting portion 323 inclines at a first angle, substantially no more than 20 degrees and the expelling portion 324 inclines at a second angle, substantially about 35 degrees, with respect to horizontal level. The first angle is smaller than the second angle.

Referring to FIGS. 1-5, in assembling of the transceiver connector 100, the top wall 11 is attached to the bottom wall 12 to form the housing 1, with the board 20 received in the housing 10. The lever 34 is mounted at the handle 311 of the actuator 31. The actuator 31 is assembled to housing 10, with the protrusions 131 of the housing 1 engaging with the mounting holes 313 of actuator 31. The sliding member 32 is mounted into the concave recess 122 along the front-to-back direction, with the platforms 133 moveable within the restricting slots 326 of the sliding member 32. The pivot 33 is inserted through the inserting holes 315 of the actuator 31, the sliding slots 132 of the housing 1, and the through hole 325 of the sliding member 32. The actuator 31 is pivotable about the mounting holes 313 and the protrusions 131. The sliding member 32 is slidable in the concave recess 122 along a front-to-back direction.

When the transceiver connector 100 is inserted into the receptacle 400, the latching protrusion 121 of the transceiver connector 100 engages with the latching hole 411 of the receptacle 400.

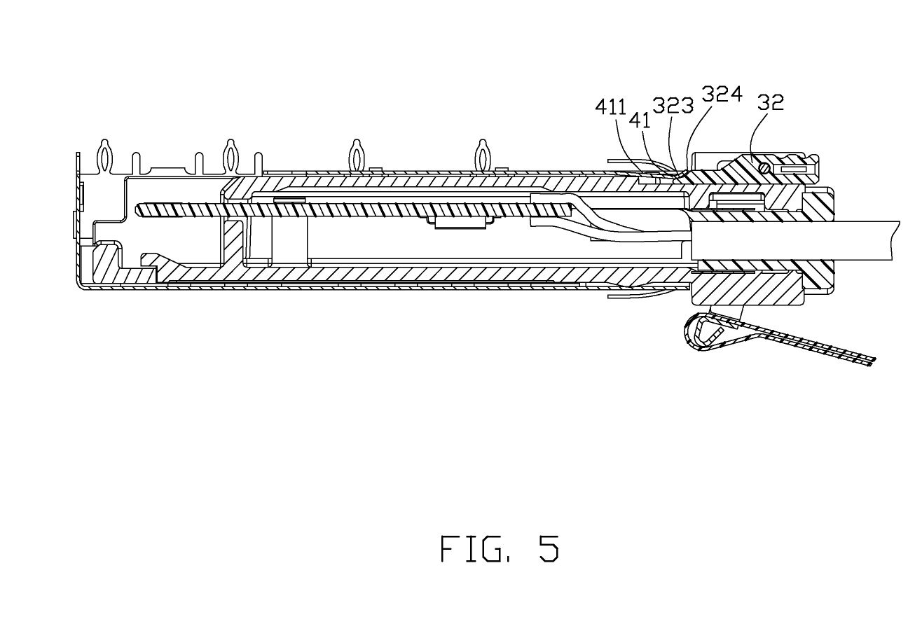

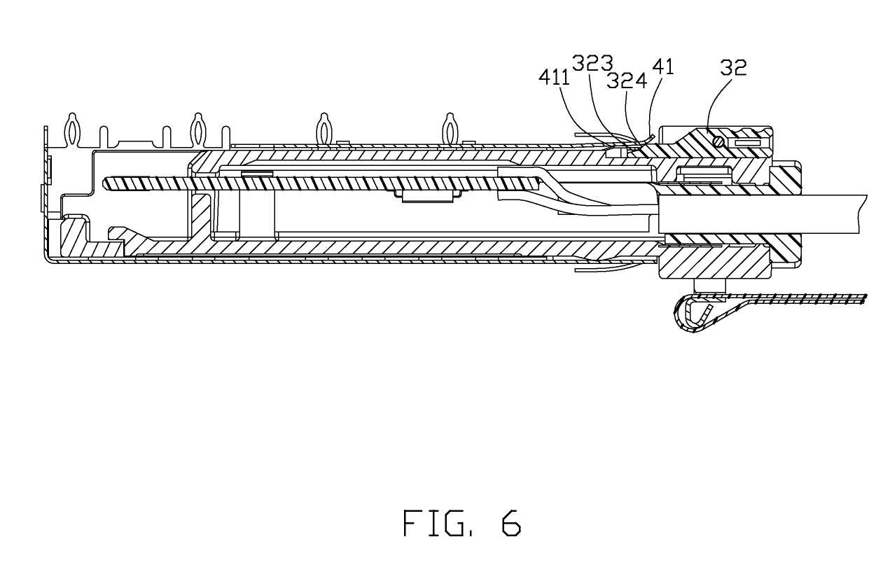

In extraction of the transceiver connector 100 from the receptacle 400, when the lever 34 is pulled rearwardly, the sliding member 32 slides forwardly in the concave recess 122 till a first position shown in FIG. 5. In the first position, the inserting portions 323 are inserted beneath the latching tab 41 of the receptacle 4. In further operation, the sliding member 32 moves forwardly from the first position to a second position shown in FIG. 6, the expelling portions 324 expels the releasing tab 41 outwardly to allow the latching protrusion 121 to escape from the latching hole 411. The sliding member 32 is blocked by the stepped portions 124 and the the platforms 133.

The inserting portion 323 of the sliding member 32 inclines at the first angle of a smaller degree, especially no more than 20 degrees relative to a horizontal, for inserting beneath the latching tab 41 easily. The expelling portion 324 of the sliding member 32 inclines at the second angle of a larger degree, especially about 35 degrees, for expelling the releasing tab 41 outwardly more easily and laborsavingly. The releasing operation is easy to perform. The releasing portion 322 inclines at one angle as described in the prior art would have the releasing operation more difficult.

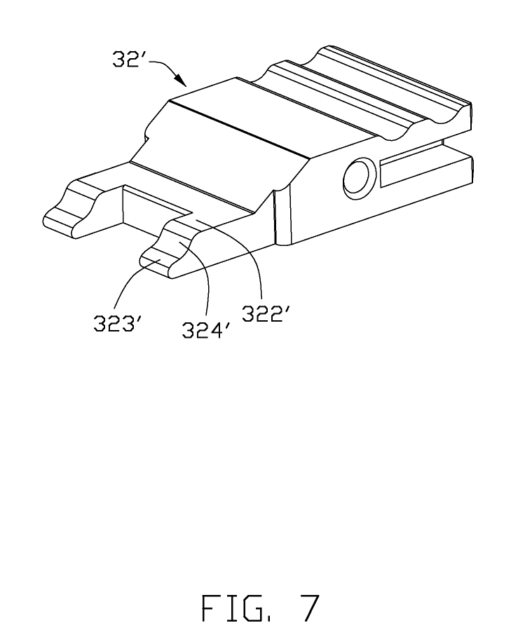

Referring to FIG. 7, in a second embodiment, the releasing portion 322′ of the sliding member 32′ is formed into a concaved circular configuration, with the inserting portion 323′ situated in front of the expelling portion 324′. A radius of curvature of the inserting portion 323′ is always smaller than that of the releasing expelling 324′.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A transceiver connector adapted for inserting into a receptacle having a latching tab defining a latching hole, comprising:
a housing having a pair of sliding slots and a latching protrusion latched with the latching hole of the receptacle; and
a releasing mechanism comprising:
an actuator defining a pair of inserting holes;
a sliding member including a through hole and at least one releasing portion having an expelling portion and an inserting portion connected with and situated in front of the expelling portion, said inserting portion inclining at a first angle smaller than a second angle at which the expelling portion inclines; and
a pivot inserting though the inserting holes of the actuator, the sliding slots of the housing and the through hole of the sliding member,
the sliding member being movable forwardly by the actuator to insert the inserting portion of the sliding member beneath the latching tab and then to move the expelling portion to expel the latching tab outwardly to release the latching protrusion from the latching hole of the receptacle.

2. The transceiver connector as claimed in claim 1, wherein said sliding member has a body portion, and there are a pair of said releasing portions extending forwardly from the body portion of the sliding member.

3. The transceiver connector as claimed in claim 2, wherein said first angle is of substantially no more than 20 degrees.

4. The transceiver connector as claimed in claim 2, wherein said second angle is of substantially 35 degrees.

5. The transceiver connector as claimed in claim 2, wherein said housing has a pair of inwardly projecting platforms respectively formed behind the sliding slots, said body portion of the sliding member having a pair of restricting slots engaging with the platforms.

6. The transceiver connector as claimed in claim 5, wherein said housing has a bottom wall, a concave recess recessed from the bottom wall for positioning the sliding member, and a pair of supporting portions formed at opposite sides of the concave recess, said latching protrusion being formed at the front end of the concave recess, said sliding slot and said platform being formed on each supporting portion.

7. The transceiver connector as claimed in claim 2, wherein said actuator comprises a handle opposite to the pair of inserting holes and a pair of mounting portions each between the handle and corresponding inserting hole, said actuator being mounted on the housing via the mounting portions and pivotable about the mounting portions.

8. The transceiver connector as claimed in claim 7, wherein said pair of mounting portions constitute a pair of mounting holes, said housing being formed with a pair of protrusions respectively inserted into the pair of mounting holes.

9. The transceiver connector as claimed in claim 7, further comprising a lever assembled to the handle of the actuator, said lever being movable along a direction opposite to another direction along which the sliding member moves.

10. A transceiver connector adapted for inserting into a receptacle having a latching tab defining a latching hole, comprising:
a housing having a pair of sliding slots and a latching protrusion latched with the latching hole of the receptacle; and
a releasing mechanism comprising:
an actuator defining a pair of inserting holes;
a sliding member including a through hole and at least one releasing portion of a concaved circular configuration, said releasing portion having an expelling portion and an inserting portion connected with and situated in front of the expelling portion; and
a pivot inserting though the inserting holes of the actuator, the sliding slots of the housing and the through hole of the sliding member,
the sliding member being movable forwardly by the actuator to insert the inserting portion of the sliding member beneath the latching tab and then to move the expelling portion to expel the latching tab outwardly to release the latching protrusion from the latching hole of the receptacle.

11. The transceiver connector as claimed in claim 10, wherein said inserting portion has a radius of curvature smaller than that of the expelling portion.

12. A transceiver connector for use with a cage, comprising:
a housing enclosing a printed circuit board defining a mating port in a front portion of the housing;
a releasing mechanism located around a rear portion of the housing and including a sliding member actuated by an actuator to back and forth move between front and rear positions in a front-to-back direction via a lever pivotally connected between the sliding member and the actuator under condition that the actuator is located upon a first face of the housing while the sliding member is positioned upon a second face opposite to the first face in a parallel relation;
a lathing protrusion formed on second face around the sliding member for latching into a latching hole of a latching tab of the cage; and
a cable connected to a rear end of the housing and electrically connected to the printed circuit board; wherein
the sliding member defines a front inserting portion and a rear expelling portion for outwardly deflecting the latching tab under condition that the inserting portion defines a first angle and the expelling portion defines a second angle larger than the first angle so as to result in two stages of unlatching the transceiver connector from the cage during outwardly deflecting the latching tab wherein a first stage is performed by the inserting portion for saving force, and a second stage is performed by the expelling portion for saving time.

13. The transceiver connector as claimed in claim 12, wherein the inserting portion and the expelling portion are located by two sides of the latching protrusion for outwardly deflecting the latching tab when said slider member is moved to the front position.
